(19) United States
(12) Patent Application Publication
(10) Pub. No.: US 2017/0216674 A1
(43) Pub. Date: Aug. 3, 2017

(54) INFORMATION PROVIDING METHOD, SYSTEM, AND TERMINAL APPARATUS

(71) Applicant: Panasonic Intellectual Property Management Co., Ltd., Osaka (JP)

(72) Inventor: KENTARO NAKAI, Hyogo (JP)

(21) Appl. No.: 15/408,578

(22) Filed: Jan. 18, 2017

(30) Foreign Application Priority Data
Jan. 28, 2016 (JP) 2016-014951
Sep. 21, 2016 (JP) 2016-184873

(51) Int. Cl. A63B 24/00; G09B 19/00; G09B 5/02; G06F 3/0482; A63B 71/06

(52) U.S. Cl. CPC A63B 24/0075; G06F 3/0482; A63B 71/0622; G09B 5/02; G09B 19/0038; A63B 24/0062; G06F 3/04817

(57) ABSTRACT

A method includes: acquiring first and second information indicating first and second exercises and first and second dates and times when a user did the first exercise and is to do the second exercise, respectively; acquiring, from the database, first and second support menus indicating a practice exercise to be performed after the first exercise, and a preparatory exercise to be performed before performing the second exercise, respectively; acquiring, from a sensor, third information indicating a fatigue level of the user measured at the first date and time; calculating first and second periods for respectively providing the first and second support menus to the user such that a total period of the first and second periods is equal to the period between the first and second dates and times; and providing the first and second support menus in the first and second periods, respectively, via a terminal of the user.

### BACKGROUND

1. Technical Field

The present disclosure relates to an information providing method and the like for supporting exercise of a user.

2. Description of the Related Art

Heretofore, an exercise support system represented by online fitness menu presentation via the Internet has been developed (see, for example, Japanese Unexamined Patent Application Publication No. 2012-248072).

However, Japanese Unexamined Patent Application Publication No. 2012-248072 needs further improving.

### SUMMARY

In one general aspect, the techniques disclosed here feature an information providing method including: acquiring, from a database, first information indicating a first exercise and a first date and time when a user carried out the first exercise, and second information indicating a second exercise and a second date and time when the user is scheduled to carry out the second exercise; acquiring, from the database, a first support menu item based on the first exercise, the first support menu item indicating a practice exercise to be performed after the first exercise; acquiring, from the database, a second support menu item based on the second exercise, the second support menu item indicating a preparatory exercise to be performed before performing the second exercise; acquiring, from a sensor, third information indicating a fatigue level of the user measured at the first date and time, the fatigue level of the user being measured by measuring a balance of a sympathetic nerve and a parasympathetic nerve of the user; based on the first date and time, the second date and time, and the fatigue level of the user, calculating a first period for providing the first support menu item to the user and a second period for providing the second support menu item to the user such that a total period of the first period and the second period is equal to a period between the first date and time and the second date and time; providing the first support menu item in the first period via a terminal apparatus of the user; and providing the second support menu item in the second period via the terminal apparatus of the user.

These general and specific aspects may be implemented using a system, a method, and a computer program, and any combination of systems, methods, and computer programs.

According to the aspect, it is possible to effectively create a schedule of exercise menus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram showing an overall image of a service provided by an exercise support system in the present disclosure;

FIG. 1B is a diagram showing an example in which an apparatus manufacturer serves as a data center operation company in the present disclosure;

FIG. 1C is a diagram showing an example of in which both or one of the apparatus manufacturer and a management company serves as the data center operation company in the present disclosure;

FIG. 2 is a block diagram showing the configuration of the exercise support system in a first embodiment;

FIG. 3 is a block diagram showing an internal configuration of a support-menu generating unit in the first embodiment and a second embodiment;

FIG. 4A is a diagram showing an example of exercise implementation history data in the first embodiment;

FIG. 4B is a diagram showing an example of exercise master data in the first embodiment;

FIG. 5A is a diagram showing an example of schedule data in the first embodiment;

FIG. 5B is a diagram showing an example of reproduction history data in the first embodiment;

FIG. 6 is a diagram showing an example of support menu master data in the first embodiment;

FIG. 7A is a diagram showing an example of a schedule GUI in the first embodiment;

FIG. 7B is a diagram showing an example of a GUI of a user-information input unit in the first embodiment;

FIG. 8A is a diagram showing a display example of a first support menu in the first embodiment;

FIG. 8B is a diagram showing a display example of a second support menu in the first embodiment;

FIG. 9A is a diagram showing an example of an update result of the schedule GUI in the first embodiment;

FIG. 9B is a diagram showing an example of an update result of the schedule GUI in the first embodiment;

FIG. 10 is a flowchart for explaining the operation of the support-menu generating unit of the exercise support system in the first embodiment;

FIG. 11 is a flowchart for explaining details of support-menu generation processing in the first embodiment;

FIG. 12 is a flowchart for explaining support-menu generation processing performed when an input is received from a user;

FIG. 13 is a block diagram showing the configuration of an exercise support system in the second embodiment;

FIG. 14 is a flowchart showing details of support-menu generation processing in the second embodiment;

FIG. 15 is a diagram showing an example of a GUI of a user-information input unit in a modification of the first embodiment;

FIG. 16 is a diagram showing an overall image of a service provided by an exercise support system in a type 1 of a service (an own company data center-type cloud service);

FIG. 17 is a diagram showing an overall image of a service provided by an exercise support system in a type 2 of the service (an IaaS-use type cloud service);

FIG. 18 is a diagram showing an overall image of a service provided by an exercise support system in a type 3 of the service (a PaaS-use type cloud service); and

FIG. 19 is a diagram showing an overall image of a service provided by an exercise support system in a type 4 of the service (a SaaS-use type cloud service).

### DETAILED DESCRIPTION

### (Underlying Knowledge Forming Basis of the Present Disclosure)

A technique for presenting to a user training menus suitable for an exercise purpose of the user has been examined. However, to achieve effective training, a user requires two kinds of support for the user to permanently acquire a correct form and a correct movement of training. One kind of support is support after the training, whereas the other kind is support for effectively performing scheduled training.

A technical solution for providing a schedule of a training menu to the user taking into account both the two kinds of support has not been examined so far. Therefore, the inventor has examined improvement measures explained below.

(1) An information providing method according to an aspect of the present disclosure includes: acquiring, from a database, first information indicating a first exercise and a first date and time when a user carried out the first exercise, and second information indicating a second exercise and a second date and time when the user is scheduled to carry out the second exercise; acquiring, from the database, a first support menu item based on the first exercise, the first support menu item indicating a practice exercise to be performed after the first exercise; acquiring, from the database, a second support menu item based on the second exercise, the second support menu item indicating a preparatory exercise to be performed before performing the second exercise; acquiring, from a sensor, third information indicating a fatigue level of the user measured at the first date and time; based on the first date and time, the second date and time, and the fatigue level of the user, calculating a first period for providing the first support menu item to the user and a second period for providing the second support menu item to the user such that a total period of the first period and the second period is equal to a period between the first date and time and the second date and time; providing the first support menu item in the first period via a terminal apparatus of the user; and providing the second support menu item in the second period via the terminal apparatus of the user.

According to this aspect, it is possible to calculate the length of the first period in which a schedule of the first support menu is created and the length of the second period in which a schedule of the second support menu is created, based on the information on the first exercise in the past in which the user participated, the information on the second exercise that the user is scheduled to carry out, and the fatigue degree of the user. Therefore, since it is possible to dynamically create a schedule of support menus according to the first exercise that the user carried out in the past, the second exercise that the user is scheduled to carry out in future, and the fatigue degree of the user, it is possible to effectively create the schedule of the support menus.

(2) The sensor may measure the fatigue level of the user by measuring a balance of a sympathetic nerve and a parasympathetic nerve of the user.

According to this aspect, it is possible to calculate the fatigue degree of the user from the balance of the sympathetic nerve and the parasympathetic nerve. It is possible to create the schedule of the support menus based on an objective fatigue degree.

(3) The information providing method may further include causing the terminal apparatus of the user to display a calendar image showing a schedule of the user, a first object indicating the first exercise may be included in a region of the calendar image associated with the first date and time, a second object indicating the second exercise may be included in a region of the calendar image associated with the second date and time, a third object indicating the first support menu item may be included in a region of the calendar image associated with the first period, and a fourth object indicating the second support menu item may be included in a region of the calendar image associated with the second period.

According to this aspect, it is possible to include, in the calendar image, the first object indicating the first exercise, the second object indicating the second exercise, the third object indicating the first support menu, and the fourth object indicating the second support menu. Therefore, it is possible to visually represent a temporal relation between the schedules of the first support menu and the second support menu and the first exercise and the second exercise. As a result, the user can easily grasp the schedules.

(4) The first period may be calculated to be longer as the fatigue level of the user is higher.

According to the aspect, it is possible to calculate, based on the fatigue degree of the user, the length of the first period in which the schedule of the first support menu is created. Therefore, as the fatigue degree after the first exercise is higher, it is possible to increase the first period in which the schedule of the first support menu is created. The user can sufficiently secure a period in which the user executes the first support menu for recovery from fatigue due to the first exercise. That is, it is possible to effectively create a schedule of the support menus.

(5) Further, the information providing method may further include: displaying, on the terminal apparatus, a user interface for correcting a length of the first period and a length of the second period; receiving, via the user interface, an instruction for causing the terminal apparatus to correct the length of the first period from a first length to a second length and to correct the length of the second period from a third length to a fourth length; and causing the terminal apparatus to display an updated calendar image including the first period having the second length and the second period having the fourth length.

According to this aspect, it is possible to receive, from the user, an input for correcting the length of the first period and the length of the second period. Therefore, the user can easily correct a schedule displayed on the calendar image. It is possible to improve convenience of the user.

(6) In the user interface, the first period may be limited to be correctable to be at least a day, and the second period may be limited to be correctable to be at least a day.

According to this aspect, it is possible to prohibit, according to an input of the user, the length of the first period in which the schedule of the first support menu is created and the length of the second period in which the schedule of the second support menu is created from being corrected beyond the limits. Therefore, it is possible to suppress an inappropriate schedule from being created by the user.

Note that these comprehensive or specific aspects may be realized as a system, an apparatus, a computer program, or a computer-readable recording medium such as a CD-ROM or may be realized as any combination of the system, the method, the integrated circuit, the computer program, and the recording medium.

### (Overall Image of a Service to be Provided)

First, an overall image of a service provided by an exercise support system in the present disclosure is explained.

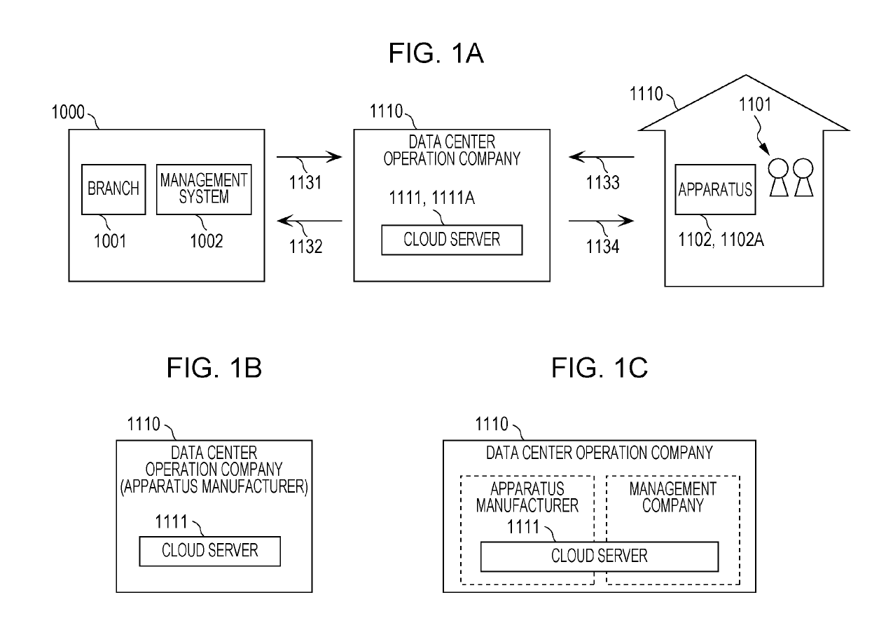

FIG. 1A is a diagram showing the overall image of the service provided by the exercise support system in the present disclosure. The exercise support system includes a branch group 1000, a data center operation company 1110, and a user group 1100. There is one or more branch groups 1000. There is one or more user groups 1100.

The branch group 1000 is, for example, a branch or an organization of a fitness club. The size of the branch group 1000 may be any size. One or more branches 1001 belong to the branch group 1000. The branch 1001 includes one or more management systems 1002.

The management system 1002 manages and stores data of one or more users who carried out exercise in the branch 1001. Note that the management system 1002 is realized by a computer physically including a communication device, a CPU (Central Processing Unit), a memory, and an external storage device such as a HDD (Hard Disk Drive). However, means for realizing the management system 1002 is not limited to the computer. The management system 1002 may be realized by a cloud server. The management system 1002 may be realized by a personal computer (PC), a smartphone, or a tablet computer.

The user group 1100 is, for example, a company, an organization, or a home. The size of the user group 1100 may be any size. One or more users 1101 belong to the user group 1100.

A user 1101 uses one or more apparatuses 1102. The apparatus 1102 is an example of a terminal apparatus and includes an apparatus (e.g., a smartphone, a personal computer, or a television) connectable to the Internet.

The data center operation company 1110 includes a cloud server 1111. The cloud server 1111 is a virtual server that cooperates with various apparatuses via the Internet. The cloud server 1111 mainly manages, for example, huge data (big data) difficult to be treated by a normal database management tool or the like. The data center operation company 1110 performs management of data, management of the cloud server 1111, operation of a data center that performs the management, and the like. Details of services performed by the data center operation company 1110 are explained below.

Note that a server managed by the data center operation company 1110 is not limited to the virtual server. The server may be a computer physically including a CPU, a memory, and an external storage device such as a HDD. The server may be a personal computer.

The data center operation company 1110 is not limited to a company that performs only the management of the data or the management of the cloud server 1111. For example, as shown in FIG. 1B, when an apparatus manufacturer that develops or manufactures one of the apparatuses 1102 performs the management of the data, the management of the cloud server 1111, and the like, the apparatus manufacturer serves as the data center operation company 1110. The data center operation company 1110 is not limited to one company. For example, as shown in FIG. 1C, when the apparatus manufacturer and a management company cooperate in or share the management of the data or the management of the cloud server 1111, both or one of the apparatus manufacturer and the management company serves as the data center operation company 1110.

A flow of information in the exercise support system shown in FIG. 1A is explained.

First, when users carry out exercise in a branch, history information (schedule data and exercise implementation history data) on the carried-out exercise is stored in the management system 1002.

The management system 1002 transmits the schedule data and the exercise implementation history data of the users in response to a request from the cloud server 1111 of the data center operation company 1110 (arrows 1131 and 1132).

The user 1101 acquires data from the cloud server 1111 of the data center operation company 1110 using the apparatus 1102 and displays a screen of an application on the apparatus 1102 (arrows 1133 and 1134).

The user 1101 displays an exercise schedule and a support menu on the apparatus 1102. The user 1101 selects a moving image from an exercise menu presented as the support menu and views the moving image. The moving image is distributed from the cloud server 1111 (the arrow 1134).

When the user 1101 views the moving image, viewing history data is transmitted to the cloud server 1111 (the arrow 1133).

For the user 1101 to use the exercise support system, access history data to the cloud server 1111 and operation history data on an application are stored in the cloud server 1111 (the arrow 1133).

The user 1101 inputs, using the apparatus 1102, a response to the presented support menu, data and the like (user information) of the user, and schedule data. The data input by the apparatus 1102 is managed on the cloud server 1111 (the arrow 1133).

Embodiments are specifically explained below with reference to the drawings.

Note that all of the embodiments explained below indicate comprehensive or specific examples. Numerical values, shapes, components, disposed positions and connection forms of the components, steps, orders of steps, and the like described in the following embodiments are examples and are not intended to limit claims. Among the components in the following embodiments, components not described in independent claims indicating most significant concepts are explained as any components. In all the embodiments and modifications of the embodiments, respective contents can also be combined.

### First Embodiment

A first embodiment is an example in which an ordinary home that receives a service is applied to a user group. A user is a member of a fitness club and participates in an exercise event carried out in a branch of the fitness club.

### [Configuration of the Exercise Support System]

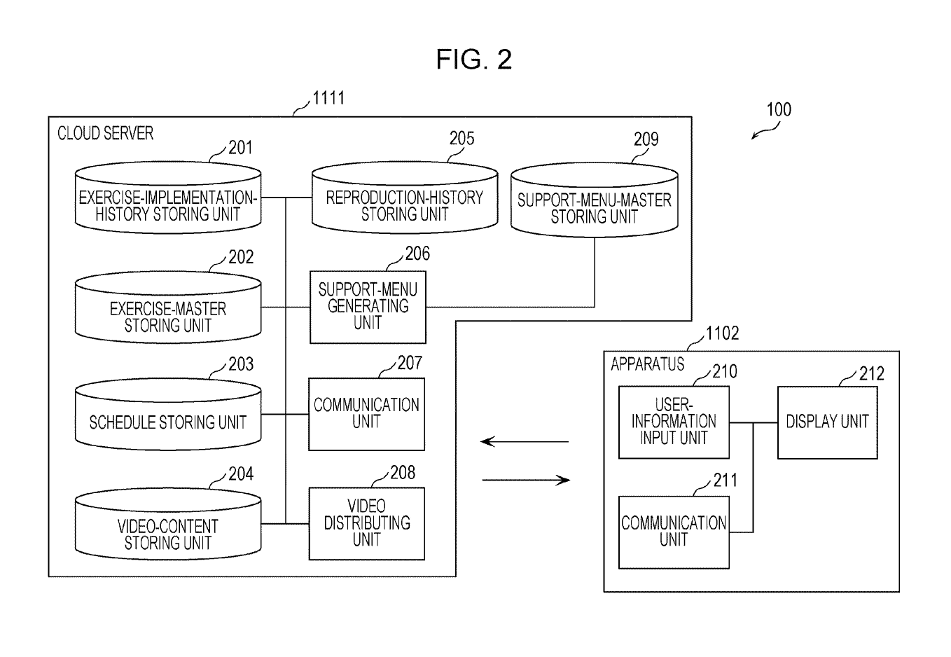

The configuration of an exercise support system 100 is explained with reference to FIG. 2. In FIG. 2, the exercise support system 100 includes the cloud server 1111 and the apparatus 1102.

The cloud server 1111 includes an exercise-implementation-history storing unit 201, an exercise-master storing unit 202, a schedule storing unit 203, a video-content storing unit 204, a reproduction-history storing unit 205, a support-menu generating unit 206, a communication unit 207, a video distributing unit 208, and a support-menu-master storing unit 209.

The apparatus 1102 includes a user-information input unit 210, a communication unit 211, and a display unit 212.

### [Configuration of the Cloud Sever]

First, blocks configuring the cloud server 1111 are explained.

The communication unit 207 is connected to a network and performs communication with the management system 1002 of the branch 1001 and the apparatus 1102 of the user via the network. The communication unit 207 is, for example, a communication interface of a wired LAN (Local Area Network) or a wireless LAN.

The video distributing unit 208 distributes, according to a reproduction instruction from the apparatus 1102 of the user, video contents of exercise to the apparatus 1102 via the communication unit 207.

In this embodiment, the video contents to be distributed are included in the support menu and are, for example, a video of stretch, a video of yoga, and a video of dance.

The support menu is a list of exercises performed by the user. The support menu includes, as items, information on one or more exercises that the user should perform. The support menu is called exercise menu as well. For example, the support menu includes video contents for the exercises that the user performs.

Note that the video contents are stored in the video-content storing unit 204.

The schedule storing unit 203 has stored therein schedule data of the user. The schedule data is stored in a user unit.

The schedule data includes information on an exercise event in the past in which the user participated (hereinafter referred to as first exercise event) and an exercise event in future in which the user is scheduled to participate (hereinafter referred to as second exercise event).

In this embodiment, for example, the first exercise event is exercise that the user performed in a branch of a fitness club. For example, the second exercise event is exercise that the user is scheduled to perform in the branch of the fitness club.

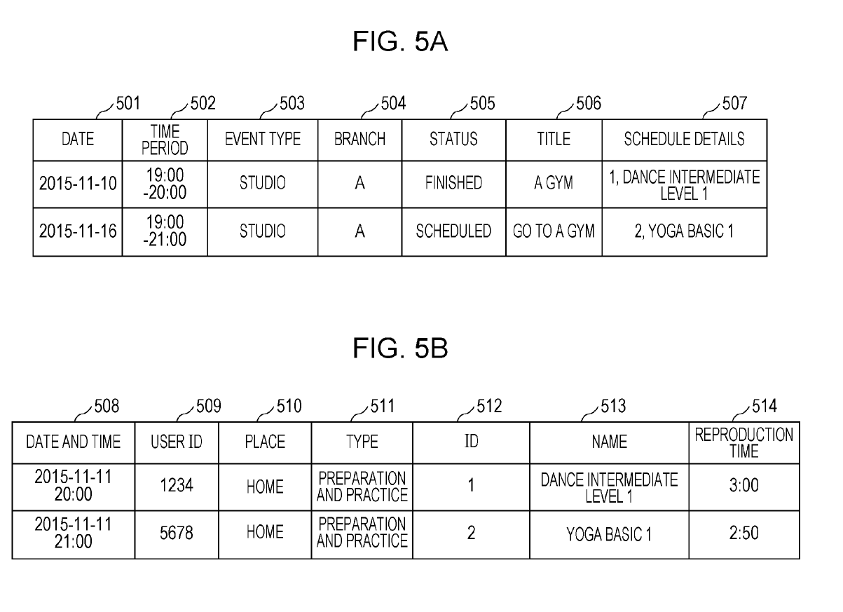

FIG. 5A shows an example of the schedule data in the first embodiment.

The schedule data includes a date 501, a time period 502, an event type 503, a branch 504, a status 505, a title 506, and schedule details 507.

The date 501 indicates a day when an event is performed. The time period 502 indicates time when the event is performed. The event type 503 indicates a type of the event. The branch 504 indicates a branch where the event is performed. The status 505 indicates whether the user already participated or is scheduled to participate in the event. For example, in the status 505, “finished” indicates an event in the past in which the user already participated. “Scheduled” indicates an event in future that the user is scheduled to participate.

The schedule details 507 indicate detailed information on exercise carried out in the event. Specifically, in the schedule details 507, text data indicating details of one or more exercises carried out in the branch of the fitness club is registered.

For example, a first row of the schedule data shown in FIG. 5A indicates a schedule of an event named “A gym”. The schedule indicates that the user already participated in an event in a branch “A” of the fitness club at “19:00 to 20:00” on “Nov. 19, 2015”. In the event, “dance intermediate level 1”, which is an exercise program with an ID “1”, is performed.

Note that, when the user visits the branch A on Nov. 19, 2015, the management system 1002 of the branch updates the status 505 of the schedule data for the user to “finished”.

An event in which the user is scheduled to participate in the schedule data is registered by the user via the user-information input unit 210 of the apparatus 1102.

Note that the user may select, using a Web application operated by the branch different from the exercise support system, from a list of exercises carried out in the branch, the event in which the user is scheduled to participate in the schedule data and inputs the event. The user may reserve a scheduled date of visit to the branch and exercise that the user will carry out. The user may select only the scheduled date of visit to the branch. The exercise that the user scheduled to carry out in the branch may be registered by a trainer belonging to the branch.

The exercise-implementation-history storing unit 201 records history information of exercise that the user carried out in the branch (hereinafter referred to as exercise implementation history data). The exercise implementation history data is acquired from the management system 1002 via the communication unit 207 and stored in the exercise-implementation-history storing unit 201.

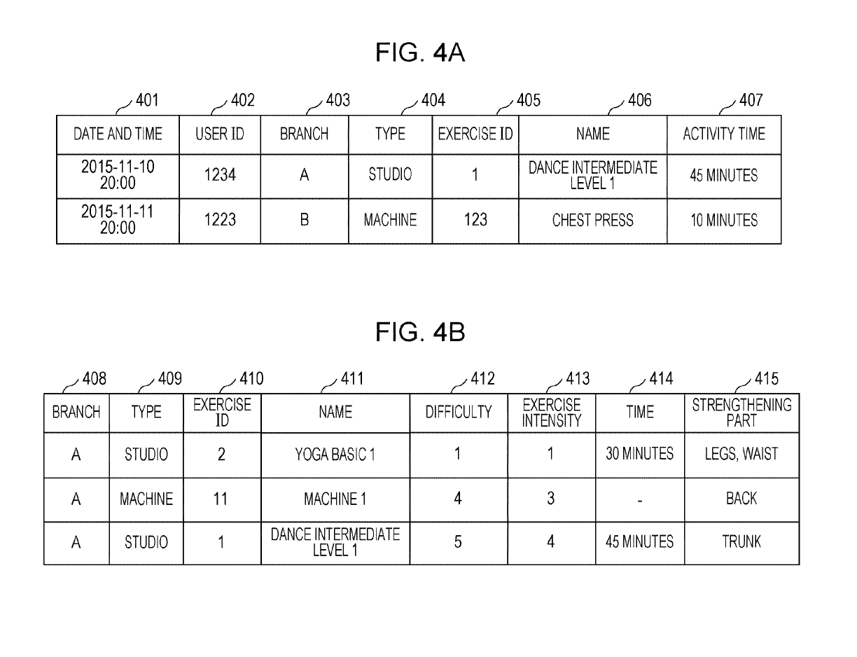

FIG. 4A shows an example of the exercise implementation history data in the first embodiment.

The exercise implementation history data includes a date and time 401, a user ID 402, a branch 403, a type 404, an exercise ID 405, a name 406, and an activity time 407.

The date and time 401 indicates date and time when the user carried out exercise. The user ID 402 indicates an identifier of the user. The branch 403 uniquely indicates a branch of the fitness club where the user carried out the exercise. The type 404 indicates a type of the exercise that the user carried out in the branch. The exercise ID 405 indicates an identifier of the exercise that the user carried out in the branch. The name 406 indicates a name of the exercise that the user carried out in the branch. The activity time 407 indicates time in which the user carried out the exercise in the branch.

For example, when the user enters a studio of the branch, the exercise implementation history data is recorded by the management system together with information on exercise in which the user participates. When the user uses a training machine, an implementation status is recorded. Note that the registration of the exercise implementation history data may be either automatic or manual.

For example, a first row of the exercise implementation history data shown in FIG. 4A indicates an exercise history of the user identified by “1234”. Specifically, the first row of the exercise history data indicates that the user “1234” carried out “dance intermediate level 1” identified by an exercise ID “1” for “45 minutes” in a “studio” of a branch “A” at “20:00 on Nov. 15, 2015”.

The exercise-master storing unit 202 retains a list of exercise information that can be carried out in one or more branches.

FIG. 4B shows an example of exercise master data in the first embodiment.

The exercise master data includes a branch 408, a type 409, an exercise ID 410, a name 411, a difficulty 412, an exercise intensity 413, a time 414, and a strengthening part 415.

The branch 408 indicates a branch where exercise is carried out. The type 409 indicates a type of the exercise. The exercise ID 410 indicates an identifier of the exercise. The name 411 indicates a name of the exercise. The difficulty 412 indicates difficulty of the exercise. The exercise intensity 413 indicates the magnitude of a load applied to a body by the exercise. The time 414 indicates time required for the exercise. The strengthening part 415 indicates a part of the body strengthened by the exercise.

Note that the exercise master data is registered in the exercise-master storing unit 202 in advance.

The reproduction-history storing unit 205 records history information of reproduction by the user of a moving image given to the support menu (hereinafter referred to as reproduction history data).

FIG. 5B shows an example of the reproduction history data in the first embodiment.

The reproduction history data includes a date and time 508, a user ID 509, a place 510, a type 511, a moving image ID 512, a name 513, and a reproduction time 514.

The date and time 508 indicates date and time when the moving image is reproduced. The user ID 509 indicates an identifier of the user. The place 510 indicates a place where the moving image is reproduced. The type 511 indicates a type of the moving image. The moving image ID 512 indicates an identifier of the moving image. The name 513 indicates a name of the moving image. The reproduction time 514 indicates the length of time in which the moving image is reproduced.

When the user reproduces, with the apparatus 1102, the moving image of the support menu presented from the exercise support system, the reproduction history data is transmitted from the apparatus 1102 to the cloud server 1111 and stored in the reproduction-history storing unit 205.

The support-menu-master storing unit 209 has stored therein a list of multiple exercise menus that the exercise support system can present to the user.

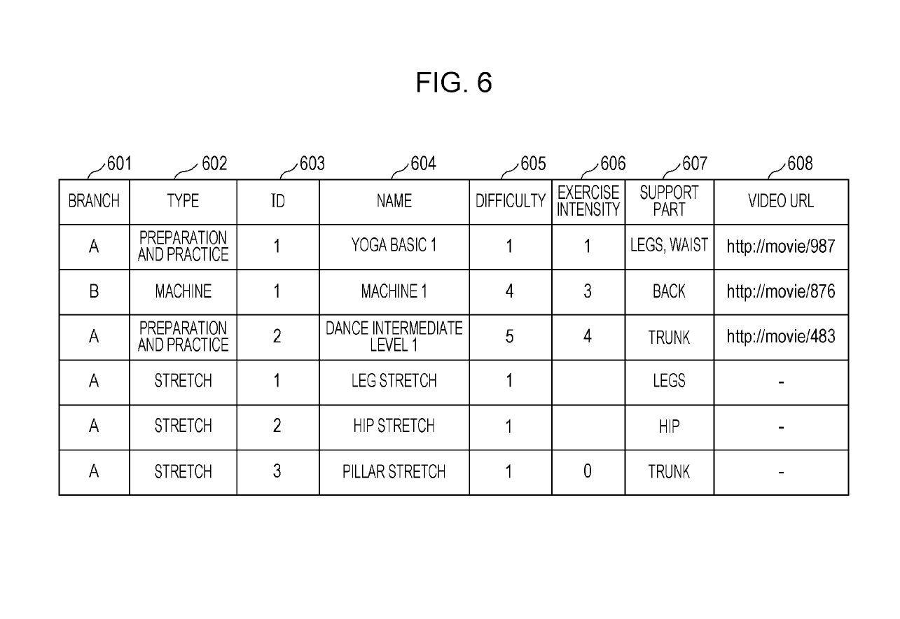

FIG. 6 shows an example of support menu master data in the first embodiment.

The support menu master data includes a branch 601, a type 602, an ID 603, a name 604, a difficulty 605, an exercise intensity 606, a support part 607, and a video URL 608.

In a first row of the support menu master data shown in FIG. 6, a support menu identified by an ID “1” is registered. A type, a name, difficulty, exercise intensity, and a support part of the support menu are respectively “preparation and practice”, “yoga basic 1”, “1”, “1”, and “legs and waist”. A branch where a support menu is carried out is “A”. A URL of a training moving image for the support menu is “http://movie/987”.

The support menu shown in the first row of FIG. 6 is a support menu for preparing or practicing “yoga basic 1” that the user carried out in the branch “A”.

Referring to the schedule data, the exercise implementation history data, and the exercise master data, the support-menu generating unit 206 calculates a period in which a schedule of the support menu is presented and a ratio (α) of a period, in which a schedule of a first support menu is present, and a ratio (β) of a period, in which a schedule of a second support menu is presented (α+β=1: initial values of α and β are 0.5), with respect to the period. The support-menu creating unit 206 creates schedule data of the first support menu and the second support menu based on the calculated ratio, and transmits the schedule data to the apparatus 1102. The first support menu is a first exercise menu for first exercise carried out in a first exercise event in the past in which the user already participated. The second support menu is a second exercise menu for second exercise carried out in a second exercise event in future in which the user is scheduled to participate.

### [Configuration of the Support-Menu Generating Unit]

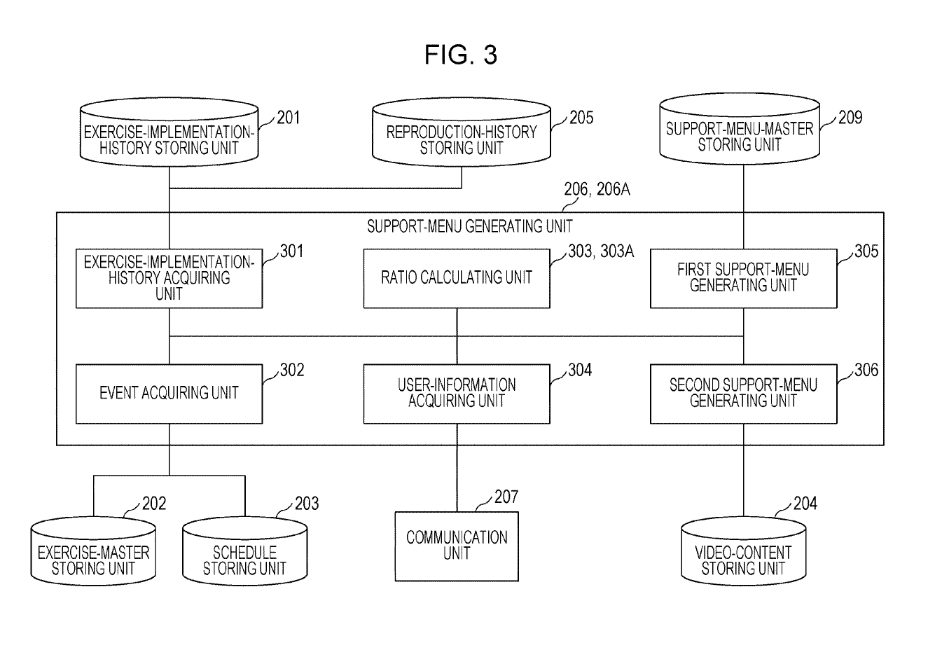

A detailed configuration of the support-menu generating unit 206 is explained with reference to FIG. 3. FIG. 3 is a block diagram showing an internal configuration of the support-menu generating unit in the first embodiment.

The support-menu generating unit 206 includes an exercise-implementation-history acquiring unit 301, an event acquiring unit 302, a ratio calculating unit 303, a user-information acquiring unit 304, a first-support-menu generating unit 305, and a second-support-menu generating unit 306.

The exercise-implementation-history acquiring unit 301 acquires information on a first date of a first exercise event in the past in which the user participated and one or more first exercises that the user carried out in the first exercise event and transmits the information to the ratio calculating unit 303. For example, the exercise-implementation-history acquiring unit 301 acquires “2015-11-10” from the date 501 of the first exercise event in the closest past and acquires “1, dance intermediate level 1” from the schedule details 507 referring to the schedule data shown in FIG. 5A. Further, the exercise-implementation-history acquiring unit 301 acquires information (e.g., difficulty “5”) on the first exercise with the exercise ID 410 “1” from the exercise master data shown in FIG. 4B.

The exercise-implementation-history acquiring unit 301 acquires reproduction history data of a training moving image from the reproduction-history storing unit 205.

The event acquiring unit 302 acquires information on a second date of a second exercise event in future in which the user is scheduled to participate and one or more second exercises that the user is scheduled to carry out in the second exercise event and transmits the information to the ratio calculating unit 303. For example, the event acquiring unit 302 acquires “2015-11-16” from the date 501 of the exercise event in the closest future and acquires “2” from the schedule details 507 referring to the schedule data shown in FIG. 5A. Further, the event acquiring unit 302 acquires, for example, information (e.g., difficulty “1”) on exercise with the exercise ID 410 “2” from the exercise master data shown in FIG. 4B.

The ratio calculating unit 303 calculates a period in which the schedule of the support menu is presented to the user, from the first date of the event in the past in which the user participated and the second date of the event in future in which the user is scheduled to participate. Based on information on the first exercise carried out in the first exercise event and information on the second exercise scheduled to be carried out in the second exercise event, the ratio calculating unit 303 determines ratios of a first period and a second period, in which the schedules of the first support menu and the second support menu are presented, with respect to the period in which the schedule of the support menu is presented.

A ratio of the first period, in which the first support menu is presented, and a ratio of the second period, in which the second support menu is presented, with respect to a period from the first date to the second date are respectively represented as “α” and “β”. The ratio α and the ratio β respectively correspond to the length of the first period in which the schedule of the first support menu for the first exercise is created and the length of the second period in which the schedule of the second support menu for the second exercise is created. That is, the ratio calculating unit 303 calculates the lengths of the first period and the second period included in the period from the first date and the second date based on at least one of the information on the first exercise and the information on the second exercise.

For example, when the first date is “10th” and the second date is “16th”, the length of the period in which the support menu is presented is calculated to be five days from 11th to 15th.

For example, using first difficulty of the first exercise and second difficulty of the second exercise, the ratio calculating unit 303 calculates a ratio of the first period, in which the first support menu is presented, and a ratio of the second period, in which the second support menu is presented, with respect to the period in which the support menu is presented.

More specifically, if the second difficulty of the second exercise is higher than the first difficulty of the first exercise, the ratio calculating unit 303 adds 0.1 to the ratio β of the second support menu and subtracts 0.1 from the ratio α of the first support menu.

On the other hand, if the first difficulty of the first exercise is higher than the second difficulty of the second exercise, the ratio calculating unit 303 adds 0.1 to the ratio α of the first support menu and subtracts 0.1 from the ratio β of the second support menu.

That is, first length of the first period calculated when the first difficulty is higher than the second difficulty is larger than second length of the first period calculated when the first difficulty is lower than the second difficulty. Third length of the second period calculated when the first difficulty is higher than the second difficulty is smaller than fourth length of the second period calculated when the first difficulty is lower than the second difficulty.

Note that the ratios α and β can be changed by an input of the user to the apparatus 1102.

When the length of the period in which the support menu is presented is an odd number of days and both of the ratios α and β are 0.5, the support menu does not have to be presented in one day in the middle of the period.

The apparatus 1102 may receive an instruction indicating which of the first support menu and the second support menu is prioritized. In this case, the user changes the ratios α and β via the user-information input unit 210 of the apparatus 1102.

Note that, in this embodiment, the first exercise and the second exercise of the first exercise event in which the user already participated and the second exercise event in which the user is scheduled to participate are one exercise. However, not only this, but, when multiple exercises are carried out in one exercise event, as difficulty, a total value of difficulties of the multiple exercises may be used.

The first-support-menu generating unit 305 generates the first support menu for one or more first exercises carried out in the first exercise event. The first support menu is presented in a day unit as a schedule in a first period (excluding the first date) starting from the first date of the first exercise event in which the user already participated. The length of the first period is given as a product of the number of days between the first date of the first exercise event in which the user already participated and the second date of the second exercise event in which the user is scheduled to participate and the ratio α. The first support menu is a training menu for practicing the first exercise.

For example, when the length of the period between the first date and the second date is five days of 11th to 15th and the ratio α of the first support menu is 0.6, the length of the first period is three (=5×0.6) days. Therefore, the first support menu is presented for three days (excluding the first date) of 11th, 12th, and 13th after the starting point of “10th”, which is the first date of the first exercise event.

Specifically, the first-support-menu generating unit 305 acquires, from the exercise implementation history data, a branch, a type, an exercise ID, and a name of the first exercise that the user carried out in the first exercise event. The first-support-menu generating unit 305 selects one or more training menus for practicing the first exercise from the support menu master data based on the acquired information, and outputs the selected one or more training menus as the first support menu.

In this embodiment, an example of a training menu is a stretch menu for relaxing a part of the body overused by the user in the first exercise that the user carried out. Another example of the training menu is a training menu for causing the user to learn forms and movements of the first exercise that the user carried out.

The second-support-menu generating unit 306 generates the second support menu for the second exercise carried out in the second exercise event in which the user is scheduled to participate. The second support menu is presented in a day unit as a schedule in the second period (excluding the second date) ending in the second date when the second exercise event in which the user is scheduled to participate is performed. The length of the second period is given as a product of the number of days between the first date of the first exercise event in which the user already participated and the second date of the second exercise event in which the user is scheduled to participate and the ratio β. The second support menu is a training menu for preparing the second exercise.

The second support menu is configured from a training menu selected from the support menu master based on information on exercise carried out in “an event scheduled to be carried out”.

For example, when the length of the period between the first date and the second date is five days of eleventh to fifteen and the ratio β of the second support menu is 0.4, the second support menu is presented for two days (excluding the second date) of fourteenth and fifteenth ending in “sixteenth”, which is the second date of the second exercise event.

Specifically, the second-support-menu generating unit 306 acquires a branch, a type, an exercise ID, and a name of the second exercise from the exercise master data, for example, based on schedule details of the schedule data. The second-support-menu generating unit 306 selects one or more training menus for preparation of the second exercise from the support menu master data based on the information acquired from the exercise master data, and outputs the selected one or more training menus as the second support menu.

The user-information acquiring unit 304 acquires user information input by the apparatus 1102 and transmits the user information to the ratio calculating unit 303. The user information is a parameter for changing the ratio α of the first support menu and the ratio β of the second support menu.

The ratio calculating unit 303 changes ratios of the first support menu and the second support menu at timing when the user information is input from the user-information acquiring unit 304 and transmits the ratios after the change to the apparatus 1102 via the communication unit 207.

### [Configuration of the Apparatus]

Blocks configuring the apparatus 1102 are explained.

The communication unit 211 is connected to a network and performs communication with the cloud server 1111 via the network. The communication unit 211 is, for example, a communication interface of a wired LAN or a wireless LAN.

The display unit 212 displays, as a GUI (Graphical User Interface), schedule data including a support menu generated by the support-menu generating unit 206. The display unit 212 is, for example, a touch display.

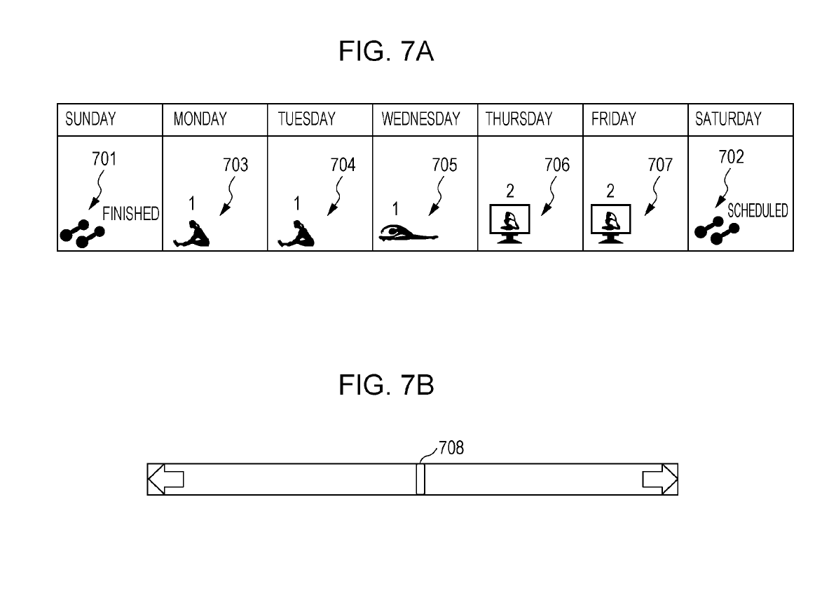

In this embodiment, the schedule GUI displayed on the display unit 212 is explained. FIG. 7A shows an example of the schedule GUI in the first embodiment.

The schedule GUI is a graphical user interface visually representing the schedule data and is an example of a schedule screen. In FIG. 7A, the schedule GUI includes a first icon 701 representing the first exercise event in which the user already participated, a second icon 702 representing the second exercise event in which the user is scheduled to participate, third icons 703 and 704 representing the first support menu for the first exercise carried out in the first exercise event, and fourth icons 705 to 707 representing the second support menu for the second exercise scheduled to be carried out in the second exercise event.

The first icon 701 is an example of a first object displayed in a region associated with the first date of the first exercise event. The second icon 702 is an example of a second object displayed in a region associated with the second date of the second exercise event. The third icons 703 and 704 are an example of a third object displayed in a region associated with the first period. The fourth icons 705 to 707 are an example of a fourth object displayed in a region associated with the second period.

In the support menu shown in FIG. 7A, the ratio α of the first period, in which the first support menu is presented, to the five days between the first date and the second date is 0.4. The ratio β of the second period, in which the second support menu is presented, to the five days is 0.6. Therefore, the length of the first period is two days. The length of the second period is three days.

Note that, in this embodiment, the schedule GUI presents the schedule data for one week. However, not only this, but the schedule GUI may present schedule data for one or more months. Multiple schedule GUIs each presenting the schedule data for one week may be displayed. Only the schedule data for one day may be presented.

Note that, in FIG. 7A, a number indicating a menu number is displayed above the icon. However, not only this, but, for example, a number indicating the number of training menus included in the support menu for the icon may be displayed around the icon. A number indicating the number of times the user carried out the support menu may be displayed.

In FIG. 7A, the third icons 703 and 704 represent a stretch for the first support menu and the fourth icons 705 to 707 represent a stretch and a video for the second support menu. However, this is not only way, but a character string or a mark such as a circle, a square, or a triangle may be displayed instead of the icon. The support menu may be displayed in a color of a frame or a background color of a region in the frame of a day of the schedule GUI. For example, a background color of a region associated with a day when the first support menu is presented may be blue and a background color of a region associated with a day when the second support menu is presented may be yellow. That is, some object indicating the first support menu or the second support menu only has to be displayed.

In the schedule GUI, when the user presses the third icons 703 and 704 or the fourth icons 705 to 707, the first support menu or the second support menu for the icons is displayed.

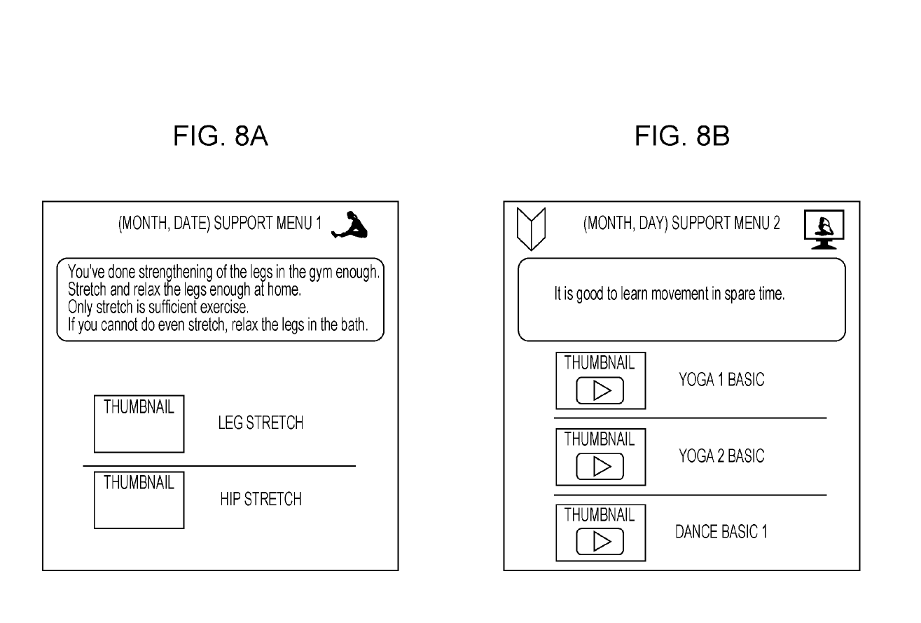

FIGS. 8A and 8B show display examples of the first support menu and the second support menu. Specifically, FIG. 8A shows the display example of the first support menu.

The first support menu includes a title of the menu, a thumbnail of a moving image, and a title of training.

In the thumbnail, a reproduction mark is displayed. When the user presses the reproduction mark, a training moving image is reproduced. In this case, reproduction history data is stored in the cloud server 1111.

Note that a trainer in charge of the user may write an explanatory note of the first support menu 1. The explanatory note may be selected at random out of multiple fixed phrases.

FIG. 8B shows the display example of the second support menu. The configuration of a screen is the same as the configuration of a screen of the first support menu.

Note that, in FIG. 8B, a mark (a beginner mark) indicating that the user has never carried out the second exercise for the support menu is displayed. The mark does not have to be displayed or another mark may be displayed.

The user-information input unit 210 receives an input from the user. For example, the user-information input unit 210 receives an input for correcting the length of the first period and the length of the second period from the user via a GUI. The user-information input unit 210 transmits input data from the user to the cloud server 1111 via the communication unit 211.

In this embodiment, the input data from the user is, for example, data for changing the ratios of the first support menu and the second support menu.

FIG. 7B shows an example of the GUI of the user-information input unit in the first embodiment.

The GUI of the user-information input unit 210 shown in FIG. 7B includes a slider 708. The user slides the slider 708 to the left and the right, whereby the ratios of the first period in which the first support menu is displayed on the schedule GUI and the second period in which the second support menu is displayed on the schedule GUI are changed.

For example, information input by the slider 708 is a fatigue degree of the body of the user. An input value of the fatigue degree is increased when the slider 708 is slid to the right. The input value of the fatigue degree is reduced when the slider 708 is slid to the left.

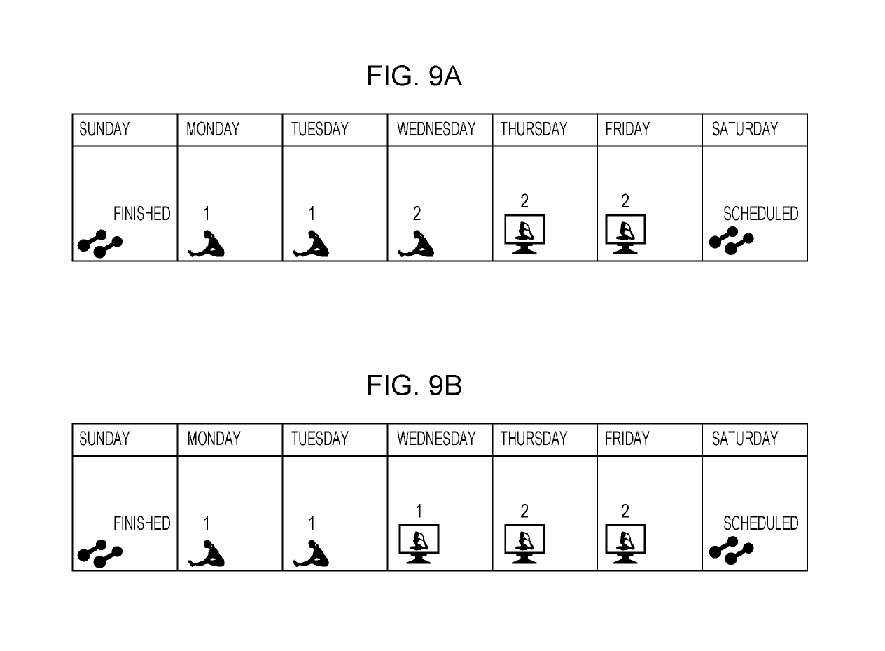

Specifically, a change in the schedule GUI at the time when the fatigue degree is input by the slider 708 shown in FIG. 7B is explained with reference to FIGS. 7A, 9A, and 9B.

In FIG. 7A, it is assumed that the present is Monday. In this case, when the user slides the slider 708 to the right, as shown in FIG. 9A, the first period in which the schedule of the first support menu is presented is extended. That is, the third icons indicating the first support menu increase and the fourth icons indicating the second support menu decrease. Consequently, a support menu of a stretch for relieving fatigue is added for a user having a high fatigue degree.

Conversely, when the user slides the slider 708 to the left, as shown in FIG. 9B, the third icons of the first support menu decrease and the fourth icons of the second support menu, which is the preparation for the second exercise, increase.

In this way, the first period increases as the input value of the fatigue degree increases. That is, the length of the first period and the length of the second period are corrected such that the length of the first period increases as the fatigue degree is higher.

Note that, in this embodiment, a change in the length of the first period and the length of the second period (i.e., the numbers of schedules in a day unit of the first support menu and the second support menu) is proportional to a slide amount of the slider 708. For example, when the slider 708 is moved to the right end, only the third icons of the first support menu are presented in the period between the first date of the first exercise event and the second date of the second exercise event in the schedule GUI. Conversely, when the slider 708 is moved to the left end, only the fourth icons of the second support menu are presented. The user can check a change in a schedule on the schedule GUI while changing the slide amount of the slider 708.

In this case, user information input by the user is transmitted to the cloud server 1111 via the communication unit 211 at any time. The support-menu generating unit 206 of the cloud server 1111 calculates ratios of the first period and the second period based on the received user information and transmits the ratios to the apparatus 1102. As a result, a schedule reflecting the user information is displayed on the schedule GUI.

Note that, in this embodiment, the user-information input unit 210 is realized using the component of the slider shown in FIG. 7B. However, not only this, but, for example, the user-information input unit 210 may be realized using a component of a slider that slides in the longitudinal direction. The user-information input unit 210 may be realized using a component of a dial for inputting information through rotation. The user-information input unit 210 may be realized by a component of a selective button. That is, the user-information input unit 210 may be realized by any GUI component. The user-information input unit 210 does not have to be realized by a GUI. For example, the user-information input unit 210 may be realized by a mechanical dial, button, or the like.

Difficulty of exercise may be input instead of the fatigue degree.

Specifically, when the user checks the second support menu presented from the exercise support system, if the user thinks that the user may be unable to perform the second exercise in the second exercise event, the user slides the slider to the left and increases the difficulty of the second exercise. Then, the second period in which the icon of the second support menu is displayed in the schedule GUI increases. The user can sufficiently perform preparation of the second exercise.

### [Operation of the Exercise Support System]

The operation of the exercise support system configured as explained above is explained.

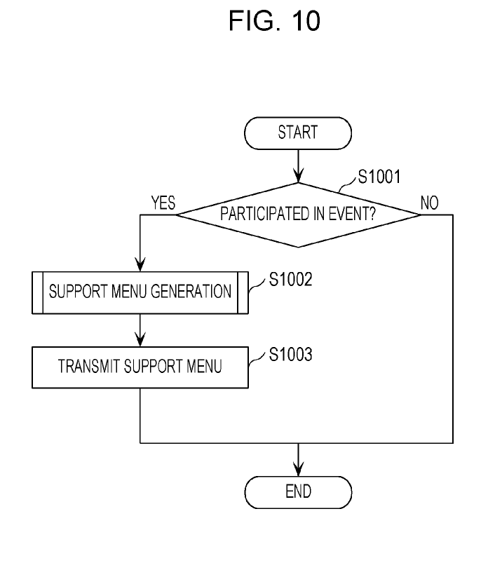

FIG. 10 is a flowchart showing the operation of the support-menu generating unit of the exercise support system in the first embodiment.

In this embodiment, a series of processing shown in FIG. 10 is executed after the user participates in an event. The series of processing shown in FIG. 10 may be carried out at any time once a day. In this case, the processing is carried out for all users who use the exercise support system.

First, the event acquiring unit 302 acquires schedule data of any user from the schedule storing unit 203. The event acquiring unit 302 acquires a schedule of the day from the schedule data and determines whether the user has participated in the event (S1001).

For example, when the day is Nov. 10, 2015, the event acquiring unit 302 acquires a record, the date 501 of which is “2015-11-10”, from the schedule data shown in FIG. 5A.

If the status 505 of the record is “finished”, it is determined that the user has participated in the event (the first exercise event) on the day (YES in S1001). Support menu generation processing is performed (S1002).

Details of the support menu generation processing are explained below. Thereafter, the support-menu generating unit 206 transmits the schedule data and a support menu to the apparatus 1102, which the user uses, via the communication unit 207 (S1003).

Consequently, the user can check the schedule data GUI and the support menu on the apparatus 1102.

On the other hand, when the user has not participated in the event on the day (NO in S1001), the processing ends.

Details of the operation in the support menu generation processing (S1002) are explained.

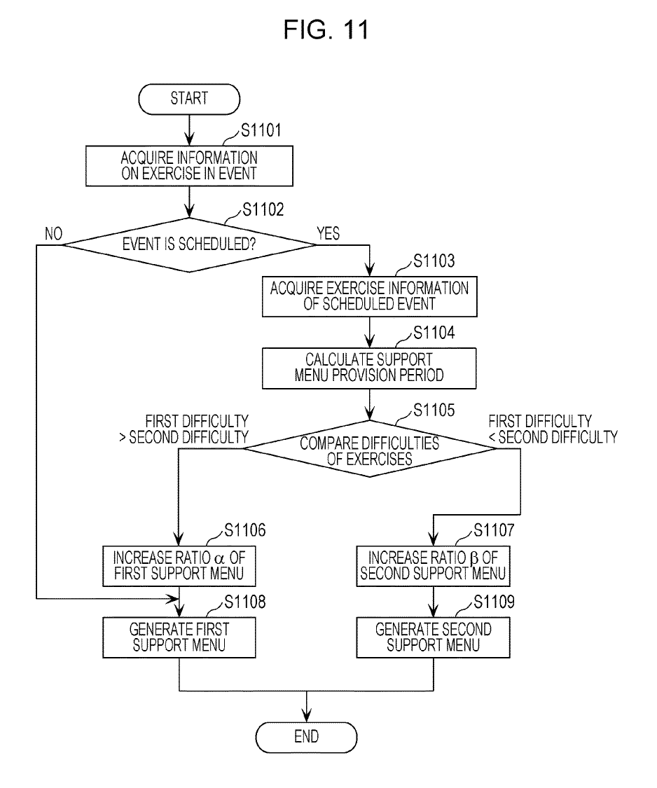

FIG. 11 is a flowchart showing details of the support menu generation processing in the first embodiment.

The exercise-implementation-history acquiring unit 301 acquires detailed information of the first exercise carried out by the user in the first exercise event from the exercise-implementation-history storing unit 201 based on the branch 504, the event type 503, and the schedule details 507 of the schedule data acquired by the event acquiring unit 302.

Further, the exercise-implementation-history acquiring unit 301 acquires difficulty of exercise, exercise intensity, and a strengthening part from the exercise master data (S1101).

In this embodiment, for example, when the day is Nov. 10, 2015, the exercise-implementation-history acquiring unit 301 acquires “A”, “studio”, and “1, dance intermediate level 1” from the branch 504, the event type 503, and the schedule details 507 of the schedule data shown in FIG. 5A. The exercise-implementation-history acquiring unit 301 selects a record, the date and time 401 of which is “2015-11-10”, the branch 403 of which is “A”, the type 404 of which is “studio”, and the name 406 of which is “dance intermediate level 1”, from the exercise implementation history data shown in FIG. 4A based on “1, dance intermediate level 1”. A record on the first row is acquired. At this same time, the exercise-implementation-history acquiring unit 301 selects a record, the branch 408 of which is “A”, the type 409 of which is “studio”, and the name 411 of which is “dance intermediate level 1”, from the exercise master data shown in FIG. 4B and acquires “5”, “4”, and “trunk” from the difficulty 412, the exercise intensity 413, and the strengthening part 415 included in the selected record.

Subsequently, the event acquiring unit 302 checks whether an event (the second exercise event) in which the user is scheduled to participate at a date and time in future from the day is present in the acquired schedule data (S1102). Specifically, the event acquiring unit 302 checks whether an event in which the user is scheduled to participate in future from the date “2015-11-10” of the day is present in the schedule data shown in FIG. 5A.

When the event (the second exercise event) in which the user is scheduled to participate is present (Yes in S1102), the event acquiring unit 302 acquires information on the second exercise scheduled to be carried out in the second exercise event from the exercise-master storing unit 202 based on the schedule details 507 of the schedule data (S1103).

Specifically, the event-acquiring unit 302 acquires a record, the data 501 of which is “2015-11-16” in future from the day and the status 505 of which is “scheduled”, from the schedule data shown in FIG. 5A as data of the second exercise event. The event acquiring unit 302 acquires “A”, “studio”, and “2, yoga basic 1” from the branch 504, the event type 503, and the schedule details 507 of the record. The event acquiring unit 302 acquires, referring to the exercise master data shown in FIG. 4B, the difficulty “1”, the exercise intensity “1”, and the strengthening part “legs and waist” included in the record coinciding with “A”, “studio”, and “2, yoga basic 1” acquired from the data of the second exercise event.

The ratio calculating unit 303 calculates a period in which the support menu is presented, based on the first date (the day) of the first exercise event and the second date of the second exercise event acquired from the schedule data (S1104).

Specifically, the ratio calculating unit 303 calculates a period in which the first support menu and the second support menu are presented, based on “2015-11-10”, which is the day when the user participated in the first exercise event, and “2015-11-16”, which is the second date of the second exercise event in which the user is scheduled to participate in the schedule data shown in FIG. 5A, as five days from Nov. 11, 2015 to Nov. 15, 2015.

Subsequently, the ratio calculating unit 303 compares the first difficulty of the first exercise carried out in the first exercise event and the second difficulty of the second exercise scheduled to be carried out in the second exercise event and calculates the ratio α and the ratio β. The ratio α is a ratio of the length of the first period, in which a schedule of the first support menu is created, to the length of the period calculated in step S1104. The ratio β is a ratio of the length of the second period, in which a schedule of the second support menu is created, to the length of the period calculated in step S1104.

It is assumed that both of initial values of the ratio α and the ratio β are 0.5.

When the first difficulty of the first exercise carried out in the first exercise event is higher than the second difficulty of the second exercise scheduled to be carried out in the second exercise event (the first difficulty>the second difficulty in S1105), the ratio calculating unit 303 increases the ratio α (S1106). At the same time, the ratio calculating unit 303 reduces the ratio β.

Specifically, the ratio calculating unit 303 adds a predetermined value m to the ratio α and subtracts m from the ratio β. For example, if m is 0.1, the ratio α is calculated to be 0.6 (=0.5+0.1) and the ratio β is calculated to be 0.4 (=0.5-0.1). In this case, the length of the first period in which the schedule of the first support menu is created and the length of the second period in which the schedule of the second support menu is created are respectively three days (=5×0.6) and two days (=5×0.4).

Specifically, referring to the exercise master data shown in FIG. 4B and the schedule data shown in FIG. 5A, the first difficulty of the first exercise acquired in step S1101 is “5” and the second difficulty of the second exercise acquired in step S1103 is “1”. In this case, since the first difficulty “5” is larger than the second difficulty “1”, the ratio calculating unit 303 increases the ratio α.

On the other hand, when the first difficulty is lower than the second difficulty (the first difficulty<the second difficulty in S1105), the ratio calculating unit 303 increases the ratio β (S1107). At the same time, the ratio calculating unit 303 reduces the ratio α.

Specifically, the ratio calculating unit 303 adds the predetermined value m to the ratio β and subtracts m from the ratio α. For example, if m is 0.1, the ratio β is calculated to be 0.6 (=0.5+0.1) and the ratio α is calculated to be 0.4 (=0.5-0.1). In this case, the length of the first period in which a schedule of the first support menu is created and the length of the second period in which a schedule of the second support menu is created are respectively two days (=5×0.4) and three days (=5×0.6).

The first-support-menu generating unit 305 selects the first support menu for the first exercise from the support-menu-master storing unit 209 and generates a schedule of the first support menu in the first period obtained from the period calculated in step S1101 and the ratio α (S1108).

Specifically, the first-support-menu generating unit 305 acquires the strengthening part “trunk” from the exercise master data based on the branch “A”, the exercise ID “1”, and the name “dance intermediate level 1” shown in FIG. 4A. The first-support-menu generating unit 305 selects, referring to the support menu master data shown in FIG. 6, a support menu having a name “pillar stretch”, the support part 607 of which is the acquired strengthening part “trunk” and the type 602 of which is “stretch”, as the first support menu.

The first-support-menu generating unit 305 selects a support menu, the type 602 of which is “preparation and practice” and the name 604 of which is “dance intermediate level 1”, as the first support menu for causing the user to learn the first exercise. A “video URL” is written in the support menu. A video is included in the support menu.

Note that, when the first difficulty and the second difficulty are equal, the first support menu and the second support menu only have to be generated using the initial values (e.g., 0.5) of the ratio α and the ratio β.

Note that, in the first embodiment, the stretch for relaxing the strengthening part of the first exercise and the practice of the first exercise are selected as the support menus. However, not only this, but, for example, the first-support-menu generating unit 305 may change, according to a period in which the first support menu is presented, a training menu selected as the first support menu.

Specifically, as the date progresses starting from the first date of the first exercise event, items included in the first support menu may be increased. The first support menu may be the same in all the days.

The second-support-menu generating unit 306 generates the second support menu by selecting, from the support menu master data of the support-menu-master storing unit 209, a training menu for preparing the second exercise scheduled to be carried out in the second exercise event in which the user is scheduled to participate (S1109).

Specifically, when the second exercise event acquired from the schedule data is “yoga basic 1”, the second-support-menu generating unit 306 selects a training menu for practicing movements and forms of yoga from the support menu master data. More specifically, the second-support-menu generating unit 306 selects a support menu, the type 602 of which is “preparation and practice” and the name 604 of which is “yoga basic 1”. The second-support-menu generating unit 306 also selects a support menu, the name 604 of which is “leg stretch”, which is a stretch for relaxing in advance “legs” included in a strengthening part of the yoga.

On the other hand, when the second exercise event is not scheduled (No in S1102), the first-support-menu generating unit 305 generates only the first support menu for supporting the first exercise of the first exercise event (S1108).

In this case, as the length of the first period in which the first support menu is presented, the length (e.g., five days) of a predetermined period only has to be used.

Support menu generation processing at the time when an input is received from the user in the apparatus 1102 is explained.

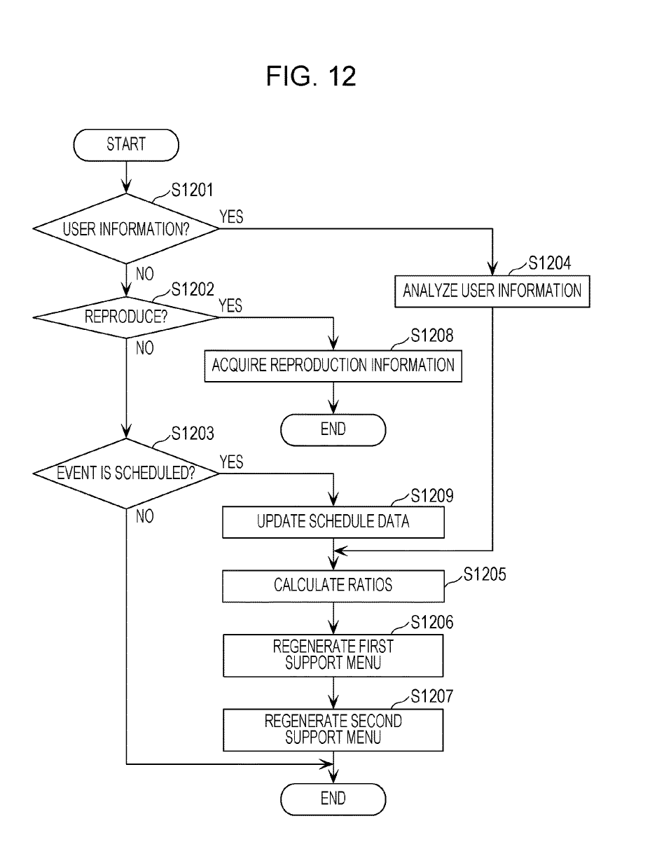

FIG. 12 is a flowchart for explaining the support menu generation processing at the time when an input is received from the user in the first embodiment.

In the flowchart, the processing is divided according to content of user information transmitted from the apparatus 1102 to the cloud server 1111.

The user information includes an input from the user for correcting the length of the first period and the length of the second period, a reproduction history by reproduction of a moving image, and an input of a schedule.

When the user information acquired by the user-information acquiring unit 304 is an input for correcting the length of the first period and the length of the second period received from the user, for example, via the GUI shown in FIG. 7B (YES in S1201), the user-information acquiring unit 304 performs an analysis of the acquired user information (S1204).

Specifically, the user-information acquiring unit 304 analyzes a change amount of the slider operated by the user on the GUI of the user-information input unit 210 of the apparatus 1102 and transmits the change amount to the ratio calculating unit 303.

Based on an analysis result, the ratio calculating unit 303 recalculates the ratio α of the first period in which a schedule of the first support menu is created and the ratio β of the second period in which a schedule of the second support menu is created (S1205). That is, the ratio calculating unit 303 corrects the length of the first period and the length of the second period based on an input from the user.

Subsequently, the first-support-menu generating unit 305 regenerates schedule data of the first support menu according to the recalculated ratio α (S1206). That is, the first-support-menu generating unit 305 updates the schedule data based on the corrected length of the first period. In this case, a schedule of the first support menu already carried out is not included in the regenerated schedule data.

The second-support-menu generating unit 306 regenerates schedule data of the second support menu according to the recalculated ratio β (S1207). That is, the second-support-menu generating unit 306 updates the schedule data based on the corrected length of the first period and the corrected length of the second period. That is, the second-support-menu generating unit 306 updates the schedule data based on the corrected length of the second period. In this case, a schedule of the second support menu already carried out is not included in the regenerated schedule data.

The schedule GUI is also updated according to the schedule data updated in this way.

Whether the first support menu or the second support menu has already been carried out is determined with reference to the reproduction history data recorded in the reproduction-history storing unit 205. In the case of a support menu not attached with a moving image, whether the first support menu or the second support menu has already been carried out may be determined according to an input of the user. Whether the first support menu or the second support menu has already been carried out may be determined based on exercise of the user recorded by an apparatus represented by an activity meter.

On the other hand, when the user information received from the apparatus 1102 is reproduction information of a moving image (NO in S1201 and YES in S1202), the user-information acquiring unit 304 acquires the reproduction information and updates the reproduction history data of the reproduction-history storing unit 205.

The reproduction history data is used to determine whether a support menu has already been carried out. Further, when the first support menu and the second support menu are recreated, the reproduction history data is used to prevent a schedule of a support menu already carried out from being regenerated.

Specifically, in the reproduction history data shown in FIG. 5B, the moving image of “dance intermediate level 1” was already reproduced on “Nov. 11, 2015”. Therefore, the first support menu or the second support menu is regenerated to prevent a schedule concerning “dance intermediate level 1” from being created.

Note that, in this embodiment, the reproduction history data is used to prevent a moving image once viewed from being included in a support menu again. However, not only this, but a menu including a moving image already reproduced may be preferentially selected during support menu generation based on the reproduction history data as a menu in which the user is interested.

When the user information received from the apparatus 1102 is schedule data including a schedule of participation in an event (NO in S1201, NO in S1202, and YES in S1203), the event acquiring unit 302 updates the schedule data stored in the schedule storing unit 203 (S1209).

The calculation of the ratios and the regeneration of the first support menu and the second support menu are performed based on the updated schedule data (S1205 to S1207).

In this case, the regeneration of the first support menu and the second support menu may be performed only when a change of schedule data of an exercise event affecting the first support menu and the second support menu is performed. For example, the regeneration of the first support menu and the second support menu may be performed only when a schedule of a most recent event in which the user is scheduled to participate (i.e., the second exercise event) is deleted or when an event in which the user is scheduled to participate more recent than the most recent event in which the user is scheduled to participate is added.

Note that, in this embodiment, when a change occurs in schedules of the first support menu and the second support menu according to update of the schedule data, a screen for check may be displayed to the user.

In this case, when the user permits, the changed schedules of the support menus may be directly presented. When the user does not permit, an input of ratio data may be received from the user. The schedules of the support menus may be changed according to the input.

Note that, in this embodiment, the user-information acquiring unit 304 may periodically monitor information transmitted from the apparatus 1102 or may acquire information only when there is a request from the apparatus 1102.

### [Effect]

As explained above, with the exercise support system according to this embodiment, it is possible to calculate, based on the information on the first exercise that the user carried out in the first exercise event in the past in which the user participated and the information on the second exercise that the user is scheduled to carry out in the second exercise event in future in which the user is scheduled to participate, the length of the first period in which a schedule of the first exercise menu is created and the length of the second period in which a schedule of the second exercise menu is created. Therefore, it is possible to dynamically create a schedule of an exercise menu according to both of the first exercise that the user carried out in the past and the second exercise that the user is scheduled to carry out in future. Therefore, it is possible to effectively create the schedule of the exercise menu.

With the exercise support system according to this embodiment, it is possible to calculate, based on the first difficulty of the first exercise and the second difficulty of the second exercise, the length of the first period in which the schedule of the first exercise menu is created and the length of the second period in which the schedule of the second exercise menu is created. Therefore, it is possible to increase a period in which a schedule of an exercise menu for exercise having high difficulty is created. The user can sufficiently secure a period in which the user executes an exercise menu for preparing or reviewing difficult exercise. That is, it is possible to effectively create the schedule of the exercise menu.

With the exercise support system according to this embodiment, it is possible to include, in the schedule GUI, the first object indicating the first exercise event, the second object indicating the second exercise event, the third object indicating the first exercise menu, and the fourth object indicating the second exercise menu. Therefore, it is possible to visually represent a temporal relation between the schedules of the first exercise menu and the second exercise menu and the first exercise event and the second exercise event. As a result, the user can easily grasp the schedules.

With the exercise support system according to this embodiment, it is possible to receive an input for correcting the length of the first period and the length of the second period from the user. Therefore, the user can easily correct a schedule displayed on the schedule screen. It is possible to improve convenience of the user.

With the exercise support system according to this embodiment, it is possible to calculate, according to an input of a fatigue degree of the user, the length of the first period in which the schedule of the first exercise menu is created. Therefore, as a fatigue degree after the first exercise is higher, it is possible to increase the first period in which the schedule of the first exercise menu is created. The user can sufficiently secure a period in which the user executes the first exercise menu for recovery from fatigue due to the first exercise. That is, it is possible to effectively create a schedule of the exercise menus.

### Second Embodiment

A second embodiment is explained. This embodiment is different from the first embodiment in that the lengths of the first period and the second period are calculated based on a fatigue degree of the user instead of the difficulty of the exercise. The fatigue degree of the user is calculated from a balance of a sympathetic nerve and a parasympathetic nerve by a sensor. This embodiment is explained below centering on differences from the first embodiment.

### [Configuration of an Exercise Support System]

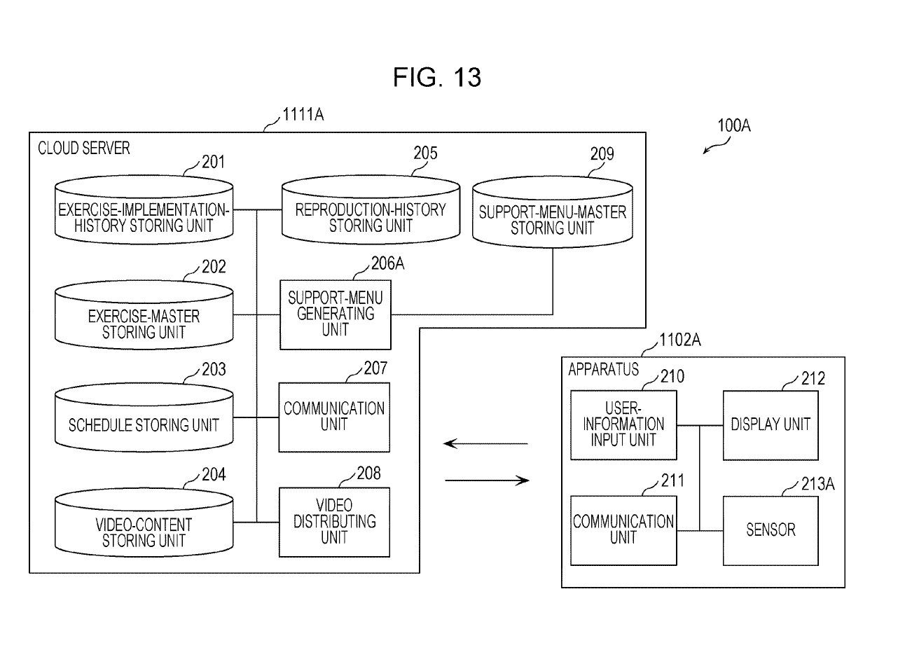

The configuration of an exercise support system 100A is explained with reference to FIG. 13. Note that, in FIG. 13, components same as or similar to the components shown in FIG. 2 are denoted by the same reference numerals and signs and explanation of the components is omitted as appropriate.

The exercise support system 100A includes a cloud server 1111A and an apparatus 1102A. The cloud server 1111A includes the exercise-implementation-history storing unit 201, the exercise-master storing unit 202, the schedule storing unit 203, the video-content storing unit 204, the reproduction-history storing unit 205, a support-menu generating unit 206A, the communication unit 207, the video distributing unit 208, and the support-menu-master storing unit 209. The apparatus 1102A includes the user-information input unit 210, the communication unit 211, the display unit 212, and a sensor 213A.

Based on a fatigue degree of a user measured by the sensor 213A, the support-menu generating unit 206A calculates the length of a first period in which a schedule of a first exercise menu is created and the length of a second period in which a schedule of a second exercise menu is created.

The sensor 213A measures the fatigue degree of the user by measuring an autonomous nerve of the user. Specifically, the sensor 213A measures a balance of a sympathetic nerve and a parasympathetic nerve of the user by, for example, measuring a heart rate and a pulse rate from a finger of the user.

### [Configuration of the Support-Menu Generating Unit]

A detailed configuration of the support-menu generating unit 206A is explained with reference to FIG. 3.

The support-menu generating unit 206A includes the exercise-implementation-history acquiring unit 301, the event acquiring unit 302, a ratio calculating unit 303A, the user-information acquiring unit 304, the first-support-menu generating unit 305, and the second-support-menu generating unit 306.

The ratio calculating unit 303A calculates a period in which a schedule of a support menu is presented to the user, from a first date of an event in the past in which the user participated and a second date of an event in future in which the user is scheduled to participate. Based on the fatigue degree of the user, the ratio calculating unit 303A determines ratios of the first period and the second period, in which schedules of a first support menu and a second support menu are presented, with respect to the period in which the schedule of the support menu is presented.

### [Operation of the Exercise Support System]

The operation of the exercise support system configured as explained above is explained.

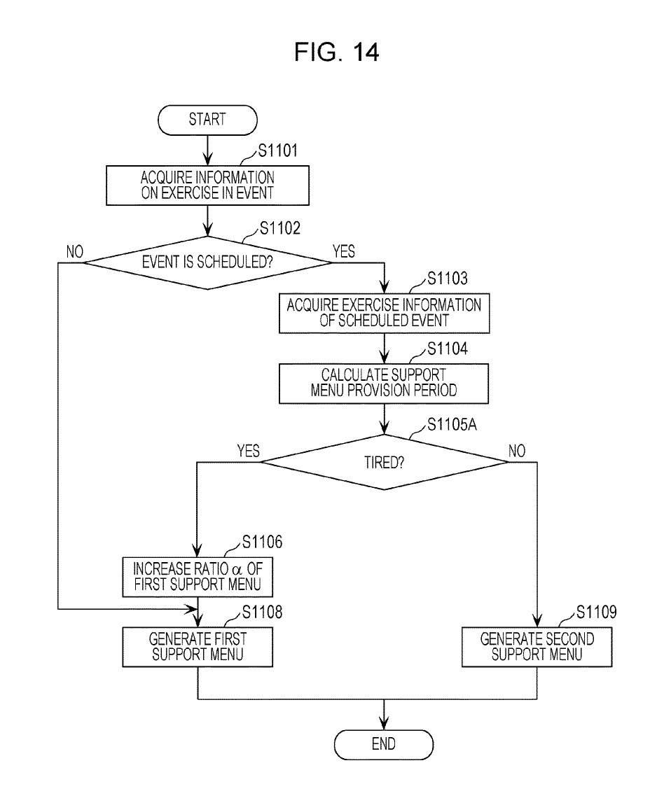

FIG. 14 is a flowchart for explaining details of a support menu generation processing in the second embodiment. Note that, in FIG. 14, steps same as or similar to the steps in FIG. 11 are denoted by the same signs and explanation of the steps is omitted as appropriate.

After step S1104 is executed, the ratio calculating unit 303A determines whether the user is tired (S1105A). Specifically, the ratio calculating unit 303A determines based on the fatigue degree measured by the sensor 213A of the apparatus 1102A whether the user is tired.

When it is determined that the user is tired (YES in S1105A), step S1106 and step S1108 are executed. When it is determined that the user is not tired (NO in S1105A), step S1109 is executed.

### [Effect]

As explained above, with the exercise support system 100A according to this embodiment, it is possible to calculate, based on the fatigue degree of the user, the length of the first period in which the schedule of the first exercise menu is created. Therefore, as the fatigue degree after the first exercise is higher, it is possible to increase the first period in which the schedule of the first exercise menu is created. The user can sufficiently secure a period in which the first exercise menu for recovery from fatigue by the first exercise is executed. That is, it is possible to effectively create the schedule of the exercise menu.

### (Modifications)

The exercise support systems according to the one or more aspects are explained above based on the embodiments. However, the present disclosure is not limited to the embodiments. Modifications conceivable by those skilled in the art applied to the embodiments may be included in the scopes of the one or more aspects as long as the modifications do not depart from the spirit of the present disclosure.

For example, the exercise support system may be realized by combining the first embodiment and the second embodiment. For example, instead of the fatigue degree input from the user in the first embodiment, a fatigue degree measured by a sensor may be used. For example, the fatigue degree measured by the sensor may be used as an initial value of a fatigue degree in a GUI that receives an input of the fatigue degree from the user.

Note that, in the second embodiment, the fatigue degree may be measured after the end of the first exercise event and registered in the exercise history data. In this case, the support-menu generating unit 206A only has to acquire the fatigue degree from the exercise history data. The fatigue degree may be measured when a support menu is generated. In this case, the support-menu generating unit 206A only has to acquire the fatigue degree from the sensor 213A.

Note that, in the second embodiment, the fatigue degree is measured based on the autonomous nerve. However, not only this, but, for example, the fatigue degree may be measured based on an activity amount of the user measured using an activity meter. For example, when an energy amount measured by the activity meter exceeds a predetermined threshold energy amount, “tired” may be determined as the fatigue degree.

Note that, in the second embodiment, the sensor 213A is included in the apparatus 1102A. However, not only this, but, for example, the sensor 213A may be included in an apparatus exclusive for fatigue degree measurement set in a fitness club.

Note that, in the second embodiment, the example is explained in which the fatigue degree is represented by two values “tired” and “not tired”. However, the fatigue degree may be represented by a value proportional to the magnitude of fatigue. In this case, the length of the first period may be determined to be proportional to the fatigue degree. The length of the first period may be determined based on a comparison result of a fatigue degree measured this time and an average of fatigue degrees measured in the past.

Note that, in the embodiments, the ratio α of the first period and the ratio β of the second period are calculated. However, the calculation of the ratio α and the ratio ρ may be omitted. For example, the length of the first period and the length of the second period may be directly calculated based on at least one of the information on the first exercise and the information on the second exercise. A ratio of the first period to the second period or a ratio of the second period to the first period may be calculated.

Note that, in the embodiments, the ratio α of the first period and the ratio β of the second period are calculated based on the difficulties, the fatigue degrees, and the like. However, the ratio α and the ratio β may be calculated based on other information on exercise. For example, the ratio α and the ratio β may be calculated based on the numbers of times of participation in exercise events in the past in which the first exercise and the second exercise were carried out. Specifically, the ratio α and the ratio β may be calculated such that values thereof decrease as the number of times of participation is larger. In this case, the length of the first period calculated when a first number of times of participation of the user in an exercise event in the past in which the first exercise was executed is larger than a second number of times of participation of the user in an exercise event in the past in which the second exercise was carried out is smaller than the length of the first period calculated when the first number of times of participation is smaller than the second number of times of participation. The length of the second period calculated when the first number of times of participation is larger than the second number of times of participation is larger than the length of the second period calculated when the first number of times of participation is smaller than the second number of times of participation.

Consequently, it is possible to calculate, based on the numbers of times of participation in the exercise events in which the first exercise and the second exercise were carried out, the length of the first period in which the schedule of the first exercise menu is created and the length of the second period in which the schedule of the second exercise menu is created. Therefore, it is possible to increase a period in which a schedule of an exercise menu for exercise that the user carried out a small number of times participating in an event is created. It is possible to effectively create a schedule of an exercise menu for preparation or practice of the exercise.

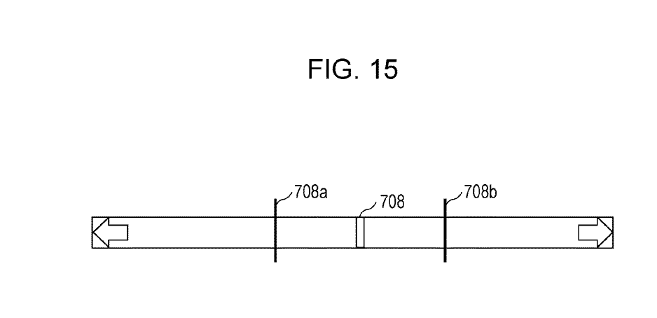

Note that, in the embodiments, the first period and the second period are freely corrected according to the input of the user. However, the correction by the input of the user may be limited. For example, for the correction of the length of the first period and the length of the second period, limitation based on the calculated length of the first period and the calculated length of the second period may be provided. For example, values to which the ratio α and the ratio β are changed according to the input of the user may be restricted from exceeding a predetermined value. In this case, in the user-information input unit, an input in which any of the length of the first period and the length of the second period exceeds the limit only has to be prohibited. Specifically, for example, as shown in FIG. 15, a lower limit line 708a and an upper limit line 708b indicating a slidable range of the slider 708 may be displayed on the GUI. In this case, movement of the slider 708 exceeding the lower limit line 708a and the upper limit line 708b is prohibited. The slidable range does not need to be always represented by the lines shown in FIG. 15 and may be represented by, for example, marks such as triangles or colors on the slider.

Consequently, the length of the first period in which the schedule of the first exercise menu is created and the length of the second period in which the schedule of the second exercise menu is created can be prohibited from being corrected to exceed the limit according to the input of the user. Therefore, it is possible to suppress an inappropriate schedule from being created by the user.

Note that the support menu in the embodiments is selected from the support menu master data. However, not only this, but, for example, an input of a first support menu and a second support menu manually generated by one or more trainers in charge of one or more users (trainees) may be received.

Note that, in the embodiments, the video contents are included in the support menu. However, not only this, but the support menu may include a text, sound, or an image instead of the video contents.

Note that, in the embodiments, the event is the event for carrying out exercise and is the event performed in the branch of the fitness club. However, not only this, but the event may be an event performed in a rehabilitation facility that instructs in exercise for recovery from injury, a company and an organization that instructs in simple exercise for preventing aging, or a hospital that performs specific health guidance. A schedule of “work” may be included in the schedule data as an event. When the schedule of the work is included in the schedule data, a schedule of a support menu created in a day same as a day of the work may be changed to a schedule of a training menu including a video that can be viewed in a train or in a short time.

Note that, in the embodiments, the numbers of days of the schedule of the first support menu and the schedule of the second support menu presented on the schedule GUI are changed according to the user information. However, not only this, but, for example, the content of the first support menu may be changed according to a “fatigue degree” input by the user. For example, the number of items included in the first support menu may be increased or reduced according to “fatigue degree” input by the user.

Note that, in the embodiments, the number of items included in the second support menu may depend on the second date of the second exercise event. For example, in a schedule of a day immediately preceding the second date, the second support menu including only an item including a video may be generated. A comment “View only a video because a scheduled date is close” may be presented. In a schedule of a day distant from the second date, a stretch menu for relaxing the strengthening part of the second exercise in advance and preparing the body for the second exercise may be generated as the second support menu.

Note that a method of generating the first support menu and the second support menu does not need to be particularly limited. Instead of the methods explained in the embodiments, other methods may be used. For example, in the embodiments, the support menu is selected from the support menu master data based on the strengthening part of the exercise. However, a method of selecting the support menu is not limited to this.

For example, when it is assumed referring to the schedule data that the user is present at home, the support-menu generating unit 206 may preferentially select, as the first support menu and the second support menu, exercise menus that the user can carry out while viewing a video on a television at home.

On a day when another schedule is already registered, the support-menu generating unit 206 may generate, as the first support menu and the second support menu, a training menu that includes a small number of items and the user can carry out in a short time. Consequently, the user can carry out the support menu in a short time, for example, during commutation and during a lunch break.

The support-menu generating unit 206 may generate the first support menu and the second support menu based on information, which is stored in the reproduction history data, concerning a place where the user viewed the support menu. For example, when the viewing place is often outside the home, the support-menu generating unit 206 may generate the first support menu and the second support menu that can be carried out in a short time.

When the viewing place is often inside the home, the support-menu generating unit 206 may generate the first support menu and the second support menu including training such as a stretch or yoga that the user can slowly carry out while viewing a television program at home.

Note that, in the embodiments, the example is explained in which the exercise support system is used in the fitness club. However, not only this, but the exercise support system may be applied to a rehabilitation facility that instructs in exercise for recovery from injury, a company and an organization that instructs in simple exercise for preventing aging, a company that provides specific health guidance, or a culture center that provides lessons.

Note that the exercise support system is usable not only in the fitness and the rehabilitation but also in schools for sports (e.g., golf, tennis, soccer, and baseball).

Note that the technique explained in the aspects can be realized in, for example, types of cloud services explained below. However, types of cloud services in which the technique explained in the aspects is realized are not limited to these types.

### (Type 1 of a Service: an Own-Company Data Center-Type Cloud Service)

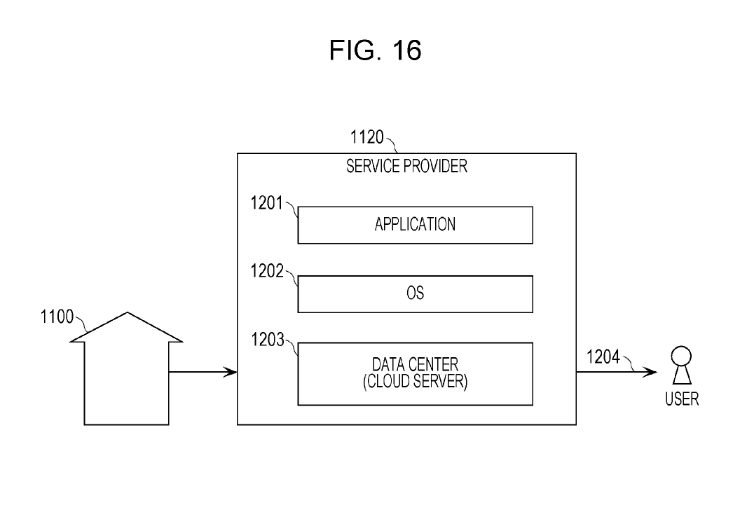

FIG. 16 is a diagram showing an overall image of a service provided by an exercise support system in a type 1 of a service (an own-company data center-type cloud service). In this type, a service provider 1120 acquires information from the group 1100 and provides the service to a user. In this type, the service provider 1120 has a function of a data center operation company. That is, the service provider 1120 owns the cloud server 1111 that manages big data. Therefore, the data center operation company is absent.

In this type, the service provider 1120 operates and manages a data center (a cloud server) 1203. The service provider 1120 manages an operating system (OS) 1202 and an application 1201. The service provider 1120 provides the service using the OS 1202 and the application 1201 managed by the service provider 1120 (an arrow 1204).

(Type 2 of a service: an IaaS-use type cloud service)

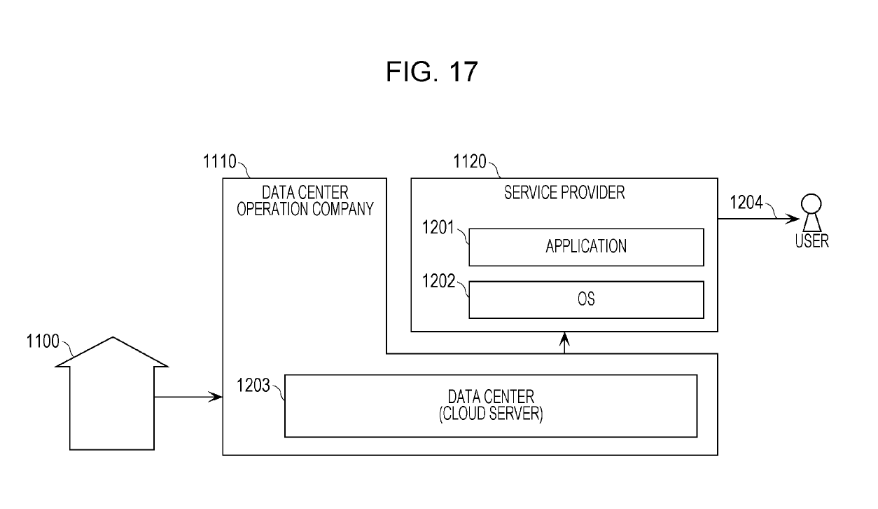

FIG. 17 is a diagram showing an overall image of a service provided by an exercise support system in a type 2 of a service (an IaaS-use type cloud service). IaaS is an abbreviation of infrastructure as a service and is a cloud service provision model that provides, as a service through the Internet, a foundation itself for constructing and operating a computer system.

In this type, the data center operation company 1110 operates and manages the data center (the cloud server) 1203. The service provider 1120 manages the OS 1202 and the application 1201. The service provider 1120 provides the service using the OS 1202 and the application 1201 managed by the service provider 1120.

### (Type 3 of a Service: a PaaS-Use Type Cloud Service)

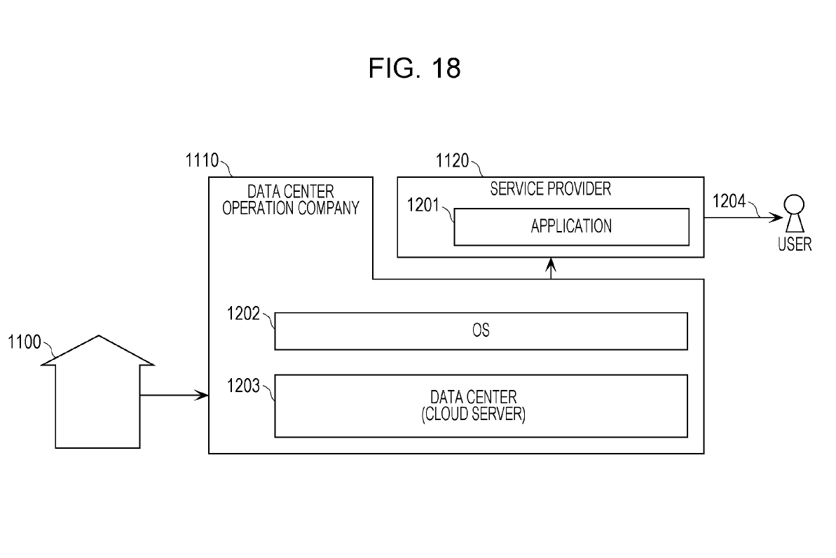

FIG. 18 is a diagram showing an overall image of a service provided by an exercise support system in a type 3 of a service (a PaaS-use type cloud service). PaaS is an abbreviation of platform as a service and is a cloud service provision model that provides, as a service through the Internet, a platform serving as a base for constructing and operating software.

In this type, the data center operation company 1110 manages the OS 1202 and operates and manages the data center (the cloud server) 1203. The service provider 1120 manages the application 1201. The service provider 1120 provides the service using the OS 1202 managed by the data center operation company 1110 and the application 1201 managed by the service provider 1120 (the arrow 1204).

### (Type 4 of a Service: an SaaS-Use Type Cloud Service)

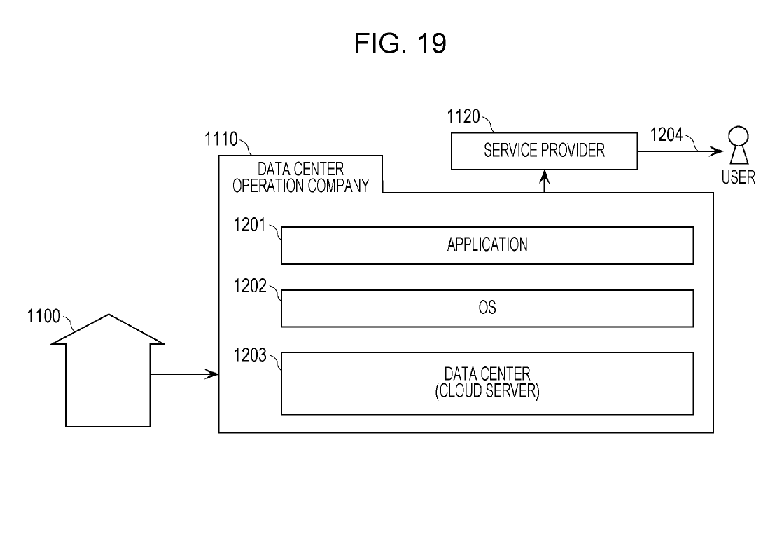

FIG. 19 is a diagram showing an overall image of a service provided by an exercise support system in a type 4 of a service (an SaaS-use type cloud service). SaaS is an abbreviation of software as a service. The SaaS-use type cloud service is a cloud service provision model including a function with which a user such as a company or an individual not owning a data center (a cloud server) can use, through a network such as the Internet, for example, an application provided by a platform provider owning the data center (the cloud server).

In this type, the data center operation company 1110 manages the application 1201, manages the OS 1202, and operates and manages the data center (the cloud server) 1203. The service provider 1120 provides the service using the OS 1202 and the application 1201 managed by the data center operation company 1110 (the arrow 1204).

As explained above, in all of the types of the cloud services, the service provider 1120 provides the services. For example, the service provider or the data center operation company may voluntarily develop an OS, an application, a database of big data, or the like or may place an order with an outside supplier for the OS, the application, the database, or the like.

The exercise support system and the exercise support method according to the aspect of the present disclosure are useful as an exercise support system and an exercise support method that can create an appropriate schedule of an exercise menu according to an exercise event in the past in which a user participated and an exercise event in future in which the user is scheduled to participate.

The exercise support system and the exercise support method can be used in, for example, the fields of fitness, rehabilitation, sports training, and specific health guidance.

What is claimed is:

1. An information providing method comprising:
acquiring, from a database, first information indicating a first exercise and a first date and time when a user carried out the first exercise, and second information indicating a second exercise and a second date and time when the user is scheduled to carry out the second exercise;
acquiring, from the database, a first support menu item based on the first exercise, the first support menu item indicating a practice exercise to be performed after the first exercise;
acquiring, from the database, a second support menu item based on the second exercise, the second support menu item indicating a preparatory exercise to be performed before performing the second exercise;
acquiring, from a sensor, third information indicating a fatigue level of the user measured at the first date and time, the fatigue level of the user being measured by measuring a balance of a sympathetic nerve and a parasympathetic nerve of the user;
based on the first date and time, the second date and time, and the fatigue level of the user, calculating a first period for providing the first support menu item to the user and a second period for providing the second support menu item to the user such that a total period of the first period and the second period is equal to a period between the first date and time and the second date and time;
providing the first support menu item in the first period via a terminal apparatus of the user; and
providing the second support menu item in the second period via the terminal apparatus of the user.

2. The information providing method according to claim 1, further comprising causing the terminal apparatus of the user to display a calendar image showing a schedule of the user, wherein
a first object indicating the first exercise is included in a region of the calendar image associated with the first date and time,
a second object indicating the second exercise is included in a region of the calendar image associated with the second date and time,
a third object indicating the first support menu item is included in a region of the calendar image associated with the first period, and
a fourth object indicating the second support menu item is included in a region of the calendar image associated with the second period.

3. The information providing method according to claim 1, wherein
the first period is calculated to be longer as the fatigue level of the user is higher.

4. The information providing method according to claim 1, further comprising:
displaying, on the terminal apparatus, a user interface for correcting a length of the first period and a length of the second period;
receiving, via the user interface, an instruction for causing the terminal apparatus to correct the length of the first period from a first length to a second length and to correct the length of the second period from a third length to a fourth length; and
causing the terminal apparatus to display an updated calendar image including the first period having the second length and the second period having the fourth length.

5. The information providing method according to claim 4, wherein,
in the user interface,
the first period is limited to be correctable to be at least a day, and
the second period is limited to be correctable to be at least a day.

6. A system comprising a server apparatus and a terminal apparatus connected to each other via a network,
the server apparatus including:
a processor;
a memory; and
a communicator, wherein
the processor
acquires, from the memory, first information indicating a first exercise and a first date and time when a user carried out the first exercise, and second information indicating a second exercise and a second date and time when the user is scheduled to carry out the second exercise,
acquires, from the memory, a first support menu item based on the first exercise, the first support menu item indicating a practice exercise to be performed after the first exercise,
acquires, from the memory, a second support menu item based on the second exercise, the second support menu item indicating a preparatory exercise to be performed before performing the second exercise,
acquires, from a sensor, third information indicating a fatigue level of the user measured at the first date and time, the fatigue level of the user being measured by measuring a balance of a sympathetic nerve and a parasympathetic nerve of the user, and
using the first date and time, the second date and time, and the fatigue level of the user to calculate a first period for providing the first support menu item to the user and a second period for providing the second support menu item to the user such that a total period the first period and the second period is equal to a period between the first date and time and the second date and time, and
the communicator provides the first support menu item in the first period via a terminal apparatus of the user and provides the second support menu item in the second period via the terminal apparatus of the user.

7. The system according to claim 6, wherein
the first period is calculated to be longer as the fatigue level is higher.

8. A terminal apparatus comprising:
a receiver that receives schedule information indicating a schedule of a user from a first date and time to a second date and time; and
a display that displays a calendar image presenting the schedule, wherein
the user carries out a first exercise at the first date and time,
the user is scheduled to carry out a second exercise at the second date and time,
a period between the first date and time and the second date and time includes a first period and a second period,
the first period indicates a period when a first support menu item indicating a practice exercise is to be performed after the first exercise,
the second period indicates a period when a second support menu item indicating a preparatory exercise is to be performed before performing the second exercise,
the first period and the second period are calculated based on the first date and time, the second date and time, and a fatigue level of the user measured by a sensor at the first date and time, the fatigue level of the user being measured by measuring a balance of a sympathetic nerve and a parasympathetic nerve of the user,
a first object indicating the first exercise is included in a region of the calendar image associated with the first date and time,
a second object indicating the second exercise is included in a region of the calendar image associated with the second date and time,
a third object indicating the first support menu item is included in a region of the calendar image associated with the first period, and
a fourth object indicating the second support menu item is included in a region of the calendar image associated with the second period.

9. The terminal apparatus according to claim 8, wherein
the first period is calculated to be longer as the fatigue level is higher.
